(19) United States
(12) Patent Application Publication
(10) Pub. No.: US 2015/0208813 A1
(43) Pub. Date: Jul. 30, 2015

(54) MATTRESS-RETENTION DECKING

(71) Applicant: L & P Property Management Company, South Gate, CA (US)

(72) Inventors: ERIC BERNARD HEEKE, HICKORY, NC (US); JACOB J. NEUENSWANDER, CARTHAGE, MO (US); WILLIAM ROBERT ROHR, JOPLIN, MO (US); GUY RUFF, MOCKSVILLE, NC (US); ZACHERY STEVEN SPENCER, CONOVER, NC (US)

(73) Assignee: L & P Property Management Company, South Gate, CA (US)

(21) Appl. No.: 14/163,497

(22) Filed: Jan. 24, 2014

(51) Int. Cl. A47C 21/02; A61G 7/015

(52) U.S. Cl. CPC A47C 21/026; A61G 7/015

(57) ABSTRACT

A mattress-retention system is provided that maintains a mattress in place on an adjustable bed base. The base has a decking with sections that articulate to move the mattress into any of a variety of support positions. The decking is typically covered with a fabric. A pattern of micro-hook strips is coupled to the fabric, facing outwardly towards the mattress. The pattern of micro-hook strips may be contained within only one section, but may also be contained in other sections, or may cross-over multiple sections. This pattern of micro-hook strips interacts with the mattress to retain it in place.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention generally relates to a decking having material for securing a mattress on an automated articulating bed. More particularly, the invention relates to a mattress-retention decking having a pattern of securing strips used to prevent a mattress from moving on the base of an automated bed during articulation.

### BACKGROUND OF THE INVENTION

Automated, articulating beds are increasing in popularity and use. In a typical adjustable bed, a base with a series of connected panels is moved into a variety of positions. The mattress rests on top of this base. It is desirable to prevent the mattress from moving with respect to the base, to keep the mattress in the correct position on the bed. A variety of methods are used to prevent a mattress from shifting past the edge of an automated bed foundation. Traditional mattress-retention methods include foot retainer bars, snaps, zippers, buckles, bars, clips, and pockets. Many of these methods help prevent a mattress from moving with respect to the base, during base articulation, such as during articulation of a Power Foundation from Leggett & Platt®. One of the main drawbacks of many of these retention methods is that they may be unsightly to a user, and may complicate the use of traditional bedding materials such as sheets or blankets on the bed. Most consumers would prefer the adjustable bed to look as much like a “normal” non-adjustable bed as possible.

Accordingly, a need exists for a reliable mattress-retention mechanism for use with an automated bedding system, which addresses the foregoing and other problems.

### BRIEF SUMMARY

A mattress-retention decking is provided that prevents a mattress from moving on an automated or adjustable bed during articulation. In one embodiment, a mattress-retention decking includes a fabric having a series or pattern of micro-hook retaining strips arranged on the decking. The micro-hook material is selected to correspondingly detachably couple to the underside of a mattress to be used on the adjustable bed. The pattern of the micro-hook strips is selected to efficiently use the micro-hook material, while providing the desired level of mattress retention. Once installed, the mattress-retention decking maintains the mattress in place relative to the adjustable bed base, while being hidden from view, and without any alteration or additional mechanisms on the mattress.

Additional objects, advantages, and novel features of the invention will be set forth in part in the description which follows, and in part will become apparent to those skilled in the art upon examination of the following, or may be learned by practice of the invention.

### BRIEF DESCRIPTION OF SEVERAL VIEWS OF THE DRAWING

The present invention is described in detail below with reference to the attached drawing figures, wherein:

FIG. 1 is a perspective view of an exemplary adjustable bed;

FIG. 2 is view similar to FIG. 1, shown without the mattress, and with the base shown schematically;

FIG. 3 is a schematic top view of two exemplary decking patterns having retaining strips; and

FIG. 4 is a schematic top view of two more exemplary decking patterns having retaining strips.

### DETAILED DESCRIPTION OF THE INVENTION

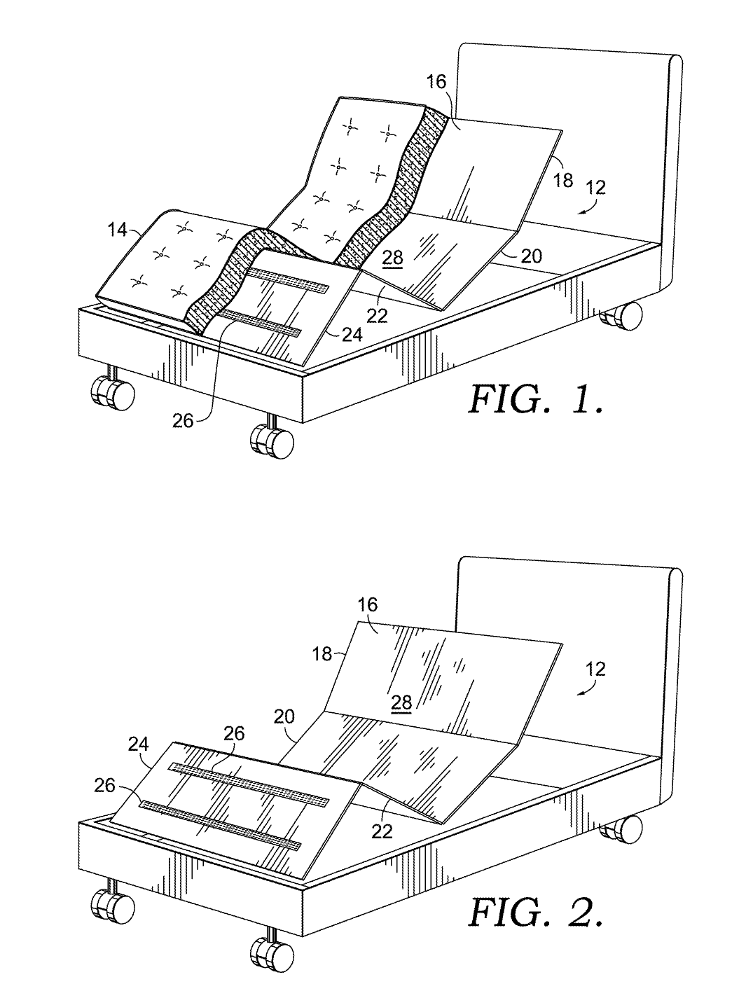

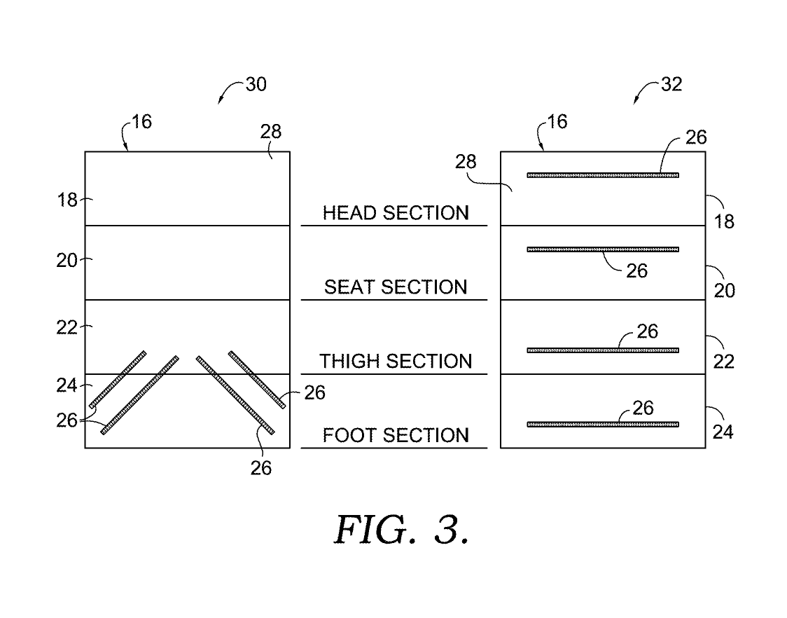

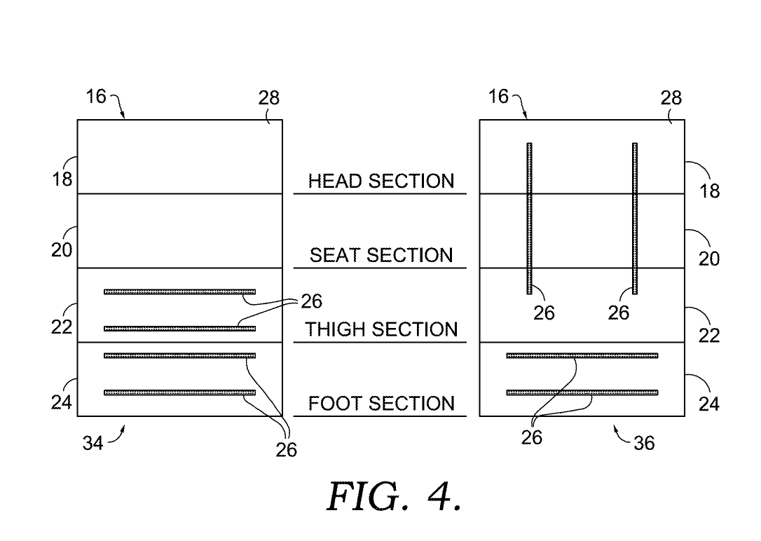

A mattress-retention decking is described below for use in maintaining a mattress 14 in place on an adjustable bed base 12. As shown in FIG. 1, and as understood by those of skill in the art, adjustable bed base 12 is operable to move the mattress 14 into a number of different positions. The mattress-retention decking prevents mattress 14 from sliding out of place relative to the bed base 12. As shown in FIG. 1, a typical adjustable bed base 12 has an articulating deck 16 that supports mattress 14. The deck 16 typically has four sections: a head section 18, a seat section 20, a thigh section 22 and a foot section 24. The deck is movable into a number of positions, such as that shown in FIG. 1, by any of a number of mechanisms known to those of skill in the art. FIG. 2 shows a view similar to FIG. 1, shown without the mattress 14. The decking has a selected one of a series of patterns of retaining strips 26, as shown in FIGS. 3 and 4. In one implementation, strips 26 are located on a fabric decking material 28 that covers the deck 16. Preferably, strips 26 are two inches wide, although other widths could be used as well. While described as being attached to a fabric 28, the strips 26 could also be directly attached or coupled to the deck 16. One exemplary material for use as strips 26 is the line of micro-hook materials available from APLIX, of Paris, France. In general, the micro-hook material is a polypropylene extrusion with micro-hooks on the face side, and smooth on the back side. The micro-hook material is slit into the proper widths, and then bonded onto fabric 28 using ultrasonic bonding technology, adhesive, glue or a pressure sensitive adhesive. The fabric 28 is preferably made for this purpose, and contained in a roll that is used for later manufacture and covering of deck 16.

As shown in FIGS. 3 and 4, strips 26 may extend across one or more sections 18, 20, 22 and/or 24, or may be isolated to be contained within a particular section. As shown schematically in the deck 16 on the left of FIG. 3, one exemplary pattern 30 involves four strips 26, arranged in a pattern with two strips 26 on either side of a center line extending longitudinally through the deck 16. Each set of two strips 26 extends diagonally from the center area of the deck 16 toward a corresponding side of the deck 16. The advantage of this pattern is that the strips need only be located in sections 22 and 24 of the deck 16.

Another exemplary pattern 32 is shown on the right side of FIG. 3. As shown in this exemplary pattern, one strip 26 is located within each section 18, 20, 22 and 24. Each strip 26 in this exemplary pattern extends generally transversely across the deck 16, from one side to the other side. In this pattern, one strip 26 is located within each section, to maintain the mattress 14 in place with respect to each corresponding section of the deck 16.

Another exemplary pattern 34 is shown on the left side of FIG. 4. As shown in this exemplary pattern, thigh section 22 and foot section 24 each contain two, parallel strips 26 extending generally transversely across the deck 16, from one side to the other side. In this exemplary pattern, as with the first-described exemplary pattern, the retaining strips 26 are located only in sections 22 and 24. But, the strips 26 in these two sections operate to maintain the mattress 14 in place with respect to the deck 16.

A final exemplary pattern 36 is shown on the right side of FIG. 4. In this exemplary pattern, two parallel strips 26 extend generally transversely across deck 16, from one side to the other side in foot section 24, similarly to that shown in pattern 34. In addition to these two strips 26, two additional strips extend generally longitudinally (from the head section 18 towards and into the thigh section 22). These longitudinally extending strips are also parallel and are located with one strip 26 on each side of the deck 16.

While particular patterns are shown for the strips 26 in FIGS. 3 and 4, other exemplary patterns may be used. Additionally, while no exact formula is currently known to calculate the minimum amount and placement of strips 26, it has been found that strips oriented transversely to the deck (side to side) appear to be more effective that strips oriented longitudinally (from head to foot).

With the fabric 28 installed on deck 16, the mattress 14 is held in place with respect to the deck 16 by the micro-hook strips 26 arranged in one of the patterns shown in FIGS. 3 and 4. Importantly, the strips 26 operate to maintain the mattress 14 in place on the deck 16 without any alteration or additional materials needed on mattress 14. The micro-hook material for strips 26 is selected to mate with the typical materials used on the underside of mattress 14. In this system, the mattress manufacturers need not necessarily alter the existing mattresses.

From the foregoing, it will be seen that this invention is one well adapted to attain all the ends and objects hereinabove set forth together with other advantages, which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

1. A mattress-retention system, for retaining an adjustable mattress on an adjustable bed frame, comprising:
an articulating decking having a plurality of sections operable to position the mattress in a plurality of positions; and
at least one strip of micro-hook material coupled to at least one of the plurality of sections of the decking.

2. The mattress-retention system of claim 1, further comprising a pattern of the strips of micro-hook material coupled to at least one of the plurality of sections of the decking.

3. The mattress-retention system of claim 2, wherein the pattern of the strips of micro-hook material is coupled to a plurality of the sections of the decking.

4. The mattress-retention system of claim 3, wherein the decking includes a head section, a seat section, a thigh section and a foot section, and wherein the pattern of the strips of micro-hook material is positioned in the thigh and foot sections.

5. The mattress-retention system of claim 3, wherein the decking includes a head section, a seat section, a thigh section and a foot section, and wherein the pattern of the strips of micro-hook material includes a strip of micro-hook material within each section and extending from one side of the decking to the other side.

6. The mattress-retention system of claim 3, wherein the decking includes a head section, a seat section, a thigh section and a foot section, and wherein the pattern of the strips of micro-hook material includes a pair of parallel strips of micro-hook material within each of the thigh section and foot section, with each of the strips extending from one side of the decking to the other side.

7. The mattress-retention system of claim 1, further comprising a fabric coupled to the decking, wherein the micro-hook material is disposed on and coupled to an exposed surface of the fabric.

8. A mattress-retention fabric for maintaining a mattress on a bed base, comprising:
a deck covering material, used to cover an articulating deck of an adjustable bed base; and
at least one strip of micro-hook material coupled to the deck covering material in a location corresponding to a desired area of the articulating deck for mattress retention.

9. The mattress-retention fabric of claim 8, wherein the articulating deck has a plurality of sections, further comprising a pattern of the strips of micro-hook material coupled to the fabric in a position usable to cover at least one of the plurality of sections of the decking.

10. The mattress-retention fabric of claim 9, wherein the pattern of the strips of micro-hook material is coupled to the fabric in a position usable to cover two or more of the plurality of sections of the decking.
